(19) United States
(12) Patent Application Publication
(10) Pub. No.: US 2010/0141698 A1
(43) Pub. Date: Jun. 10, 2010

(54) LIQUID DISCHARGING APPARATUS AND LIQUID DISCHARGING METHOD

(75) Inventors: Yoshiyuki Suzuki, Suwa-shi (JP); Kinya Ozawa, Suwa-shi (JP); Junhua Zhang, Suwa-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/630,639

(22) Filed: Dec. 3, 2009

(30) Foreign Application Priority Data
Dec. 5, 2008 (JP) 2008-311325

(51) Int. Cl. B41J 29/38

(52) U.S. Cl. 347/11

(57) ABSTRACT

A liquid discharging apparatus includes: a pressure chamber that is in communication with a nozzle; an element that operates to cause a pressure change in liquid retained in the pressure chamber; and a discharging pulse generating unit that generates a discharging pulse for operating the element to discharge the liquid from the nozzle, wherein the discharging pulse generating unit generates an anterior discharging pulse and a posterior discharging pulse in such a manner that a time period A from the end of the anterior discharging pulse to the start of the posterior discharging pulse satisfies the following formula (1).

$$O ≦ A ≦ Xv max - \frac{1}{20} Tc \qquad ( 1 )$$

### BACKGROUND

1. Technical Field

The present invention relates to a liquid discharging apparatus and a liquid discharging method.

2. Related Art

A liquid discharging apparatus such as an ink-jet printer is known in the art. Some liquid discharging apparatus discharge liquid that has approximately the same level of viscosity as the viscosity level of water, which is approximately one millipascal second. In the discharging operation, a discharging pulse that includes a damping element (i.e., pulse segment) is used in order to dampen the excessive vibration of meniscus promptly after the discharging of liquid. The meniscus is a free surface of ink that is exposed at a nozzle. An example of such a discharging pulse is disclosed in, for example, JP-A-2003-326716 (refer to FIGS. 7 and 14). The discharging pulse drives a piezoelectric element to carry out a depressurization step, a discharging step, and a vibration suppression step. A pressure generation chamber expands in the depressurization step. In the discharging step, the pressure generation chamber contracts so as to discharge a liquid drop. The pressure generation chamber expands again in the vibration suppression step.

Recently, an attempt has been made to discharge liquid that has a higher viscosity level than that of conventional liquid by utilizing a technique of an ink jet printer. The liquid that has a higher viscosity level may be hereinafter referred to as “high-viscosity liquid”. When a conventional discharging pulse is used for discharging high-viscosity liquid, it is difficult to ensure sufficient capacity for the first expansion operation because it is necessary start the first expansion from an intermediate voltage level. A conceivable solution to such a problem is to use a discharging pulse that has the shape of a trapezoidal pulse. However, when a trapezoidal discharging pulse is used, it is difficult to ensure stable discharging of liquid drops if no consideration is given to a time interval between a preceding discharging pulse and a following discharging pulse.

### SUMMARY

An advantage of some aspects of the invention is to discharge high-viscosity liquid with stable performance.

In order to offer the above features and advantages, a main aspect of the invention provides a liquid discharging apparatus that includes: a pressure chamber that is in communication with a nozzle; an element that operates to cause a pressure change in liquid retained in the pressure chamber; and a discharging pulse generating section that generates a discharging pulse for operating the element to discharge the liquid from the nozzle, wherein the discharging pulse generating section generates an anterior discharging pulse and a posterior discharging pulse in such a manner that a time period A from the end of the anterior discharging pulse to the start of the posterior discharging pulse satisfies the following formula (1).

$$O ≦ A ≦ Xv max - \frac{1}{20} Tc \qquad ( 1 )$$

Other features and advantages offered by the invention will be fully understood by referring to the following detailed description in conjunction with the accompanying drawings.

### BRIEF DESCRIPTION OF THE DRAWINGS

The invention will be described with reference to the accompanying drawings, wherein like numbers reference like elements.

FIG. 1 is a block diagram that schematically illustrates an example of the configuration of a printing system that includes a printer according to an exemplary embodiment of the invention.

FIG. 2 is a sectional view that schematically illustrates an example of the structure of a head unit according to an exemplary embodiment of the invention.

FIG. 3 is another sectional view that schematically illustrates an example of the structure of the head unit according to an exemplary embodiment of the invention.

FIG. 4 is a diagram that conceptually illustrates an example of a pressure generation chamber, an ink supply passage, and a nozzle of a head according to an exemplary embodiment of the invention.

FIG. 5 is a diagram that schematically illustrates an example of the shape of the nozzle according to an exemplary embodiment of the invention.

FIG. 6 is a perspective view that schematically illustrates an example of the structure of a piezoelectric element unit according to an exemplary embodiment of the invention.

FIG. 7A is a plan view that schematically illustrates an example of the structure of the piezoelectric element unit according to an exemplary embodiment of the invention.

FIG. 7B is a sectional view taken along the line VIIB-VIIB of FIG. 7A.

FIG. 8 is a block diagram that schematically illustrates an example of the configuration of a driving signal generation circuit and other components according to an exemplary embodiment of the invention.

FIG. 9 is a diagram that schematically illustrates an example of the signal waveform of a driving signal according to an exemplary embodiment of the invention.

FIG. 10 is a graph that shows an example of a relationship between a pulse interval (time period A) from the end of a preceding discharging pulse to the start of a following discharging pulse and the “in-the-air” moving speed of an ink drop that is discharged when driven by the following discharging pulse according to an exemplary embodiment of the invention.

FIG. 11 is a table that shows measurement data on the basis of which points are plotted in the graph of FIG. 10.

FIG. 12 is a diagram that shows a result of the evaluation of stability performance when an ink drop is discharged.

FIG. 13 is a diagram that schematically illustrates an example of meniscus movement when the preceding discharging pulse is applied to a piezoelectric element.

### DESCRIPTION OF EXEMPLARY EMBODIMENTS

Referring to the following detailed description in conjunction with the accompanying drawings, one will fully understand at least the following inventive concept of the invention.

A liquid discharging apparatus having the following features is disclosed in the detailed description of the invention and the accompanying drawings. The liquid discharging apparatus includes: a pressure chamber that is in communication with a nozzle; an element that operates to cause a pressure change in liquid retained in the pressure chamber; and a discharging pulse generating section that generates a discharging pulse for operating the element to discharge the liquid from the nozzle, wherein the discharging pulse generating section generates an anterior discharging pulse and a posterior discharging pulse in such a manner that a time period A from the end of the anterior discharging pulse to the start of the posterior discharging pulse satisfies the following formula (1).

$$O ≦ A ≦ Xv max - \frac{1}{20} Tc \qquad ( 1 )$$

In the above formula, Xvmax is an interval from the end of an anterior discharging pulse to the start of a posterior discharging pulse at which the highest movement velocity of a liquid drop in the air is obtained when driven by the posterior discharging pulse. In the above formula, Tc is a Helmholtz frequency, that is, the natural vibration frequency or the eigenfrequency of liquid retained in a pressure generation chamber. A liquid discharging apparatus having the above features makes it possible to discharge a liquid drop with stable performance.

In addition, a liquid discharging apparatus having the following features is disclosed in the detailed description of the invention and the accompanying drawings. The liquid discharging apparatus includes: a pressure chamber that is in communication with a nozzle; an element that operates to cause a pressure change in liquid retained in the pressure chamber; and a discharging pulse generating section that generates a discharging pulse for operating the element to discharge the liquid from the nozzle, wherein the discharging pulse generating section generates an anterior discharging pulse and a posterior discharging pulse in such a manner that a time period A from the end of the anterior discharging pulse to the start of the posterior discharging pulse satisfies the following formula (2).

$$Xv max + ( \frac{10 n + 1}{20} ) Tc ≦ A ≦ Xv max + ( \frac{10 n + 9}{20} ) Tc \qquad ( 2 )$$

In the above formula, n equals to zero or one. A liquid discharging apparatus having the above features makes it possible to discharge a liquid drop with stable performance.

In addition, a liquid discharging apparatus having the following features is disclosed in the detailed description of the invention and the accompanying drawings. The liquid discharging apparatus includes: a pressure chamber that is in communication with a nozzle; an element that operates to cause a pressure change in liquid retained in the pressure chamber; and a discharging pulse generating section that generates a discharging pulse for operating the element to discharge the liquid from the nozzle, wherein the discharging pulse generating section generates an anterior discharging pulse and a posterior discharging pulse in such a manner that a time period A from the end of the anterior discharging pulse to the start of the posterior discharging pulse satisfies the following formula (3) when the element is operated through application of the anterior discharging pulse and the posterior discharging pulse in order to discharge a liquid drop of a certain desired discharge amount.

$$Xv max + \frac{1}{20} Tc ≦ A ≦ Xv max + \frac{9}{20} Tc \qquad ( 3 )$$

A liquid discharging apparatus having the above features makes it possible to discharge a liquid drop of a certain desired discharge amount with stable performance when driven by an anterior discharging pulse and a posterior discharging pulse.

In a liquid discharging apparatus having the above features, it is preferable that the anterior discharging pulse should be a trapezoidal pulse; and the posterior discharging pulse should be a trapezoidal pulse that has the same voltage level change pattern as that of the anterior discharging pulse. A liquid discharging apparatus having the preferred features described above makes it possible to discharge a liquid drop with stable performance.

In a liquid discharging apparatus having the above features, it is preferable that the element should be a piezoelectric element that becomes deformed in accordance with the voltage level of an applied discharging pulse to cause a change in the capacity of the pressure chamber, thereby causing a pressure change in the liquid retained in the pressure chamber. A liquid discharging apparatus having the preferred features described above makes it possible to control pressure that is applied to the liquid finely.

In addition, a liquid discharging method having the following features is disclosed in the detailed description of the invention and the accompanying drawings. A liquid discharging method includes: generating an anterior discharging pulse and a posterior discharging pulse; and applying the anterior discharging pulse and the posterior discharging pulse successively to an element that operates to cause a pressure change in liquid retained in a pressure chamber, thereby discharging a liquid drop from a nozzle that is in communication the pressure chamber, wherein the viscosity of the liquid is ten millipascal seconds or greater, and a time period A from the end of the anterior discharging pulse to the start of the posterior discharging pulse satisfies the following formula (1).

$$O ≦ A ≦ Xv max - \frac{1}{20} Tc \qquad ( 1 )$$

A liquid discharging method having the following features is disclosed in the detailed description of the invention and the accompanying drawings. A liquid discharging method includes: generating an anterior discharging pulse and a posterior discharging pulse; and applying the anterior discharging pulse and the posterior discharging pulse successively to an element that operates to cause a pressure change in liquid retained in a pressure chamber, thereby discharging a liquid drop from a nozzle that is in communication the pressure chamber, wherein the viscosity of the liquid is ten millipascal seconds or greater, and a time period A from the end of the anterior discharging pulse to the start of the posterior discharging pulse satisfies the following formula (2).

$$Xv max + ( \frac{10 n + 1}{20} ) Tc ≦ A ≦ Xv max + ( \frac{10 n + 9}{20} ) Tc \qquad ( 2 )$$

A liquid discharging method having the following features is disclosed in the detailed description of the invention and the accompanying drawings. A liquid discharging method includes: generating an anterior discharging pulse and a posterior discharging pulse; and applying, in order to discharge a liquid drop of a certain desired discharge amount, the anterior discharging pulse and the posterior discharging pulse successively to an element that operates to cause a pressure change in liquid retained in a pressure chamber, thereby discharging the liquid drop from a nozzle that is in communication the pressure chamber, wherein the viscosity of the liquid is ten millipascal seconds or greater, and a time period A from the end of the anterior discharging pulse to the start of the posterior discharging pulse satisfies the following formula (3).

$$Xv max + \frac{1}{20} Tc ≦ A ≦ Xv max + \frac{9}{20} Tc \qquad ( 3 )$$

### First Embodiment

### Printing System

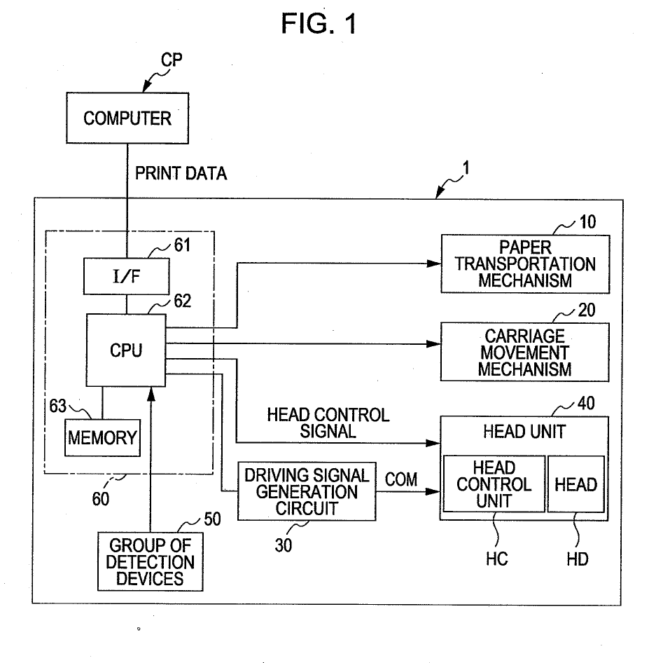

As illustrated in FIG. 1, a printing system according to an exemplary embodiment of the invention is provided with a printer 1 and a computer CP. The printer 1, which is an example of various kinds of liquid discharging apparatuses, is capable of ejecting ink toward various kinds of liquid discharging target media such as a sheet of printing paper, cloth, film, or the like. Ink is an example of various kinds of liquid that can be discharged from a liquid discharging apparatus. A liquid discharging target medium is a target object onto which liquid is discharged. The computer CP is connected to the printer 1 so that they can perform communication therebetween. The computer CP transmits print data corresponding to a print-instructed image to the printer 1 when the computer CP causes the printer 1 to perform printing.

### Overall Configuration of Printer 1

The printer 1 includes a paper transportation mechanism 10, a carriage movement mechanism 20, a driving signal generation circuit 30, a head unit 40, a group of detection devices 50, and a printer-side controller 60.

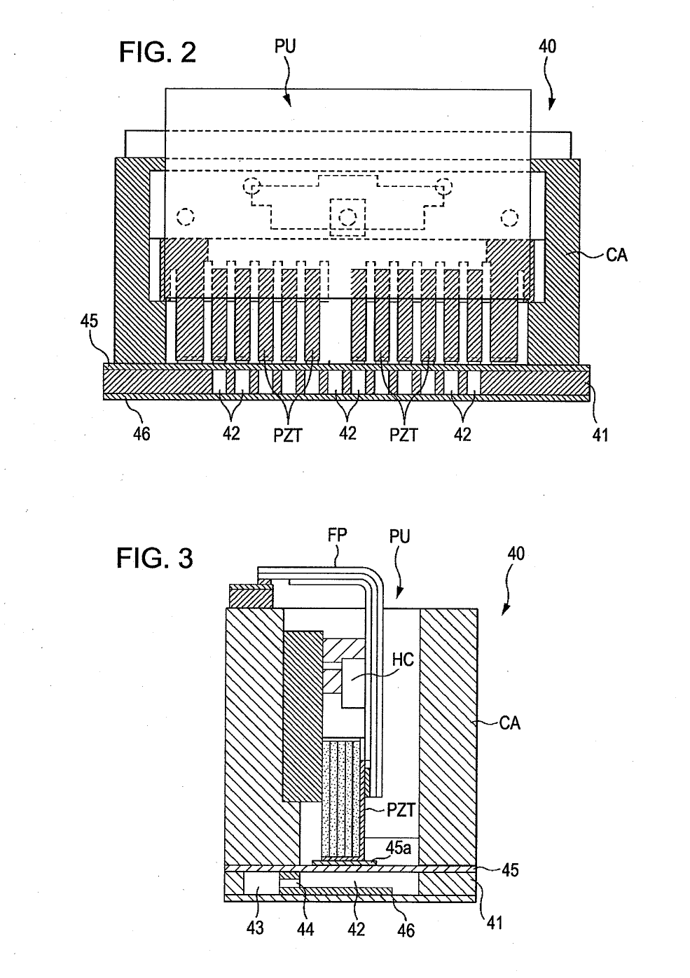

The paper transportation mechanism 10 transports a sheet of printing paper in a paper transport direction. The carriage movement mechanism 20 moves a carriage on which the head unit 40 is mounted in a predetermined movement direction (for example, a paper width direction). The driving signal generation circuit 30 generates a driving signal COM. The driving signal COM is applied to piezoelectric elements PZT of a head HD (refer to FIG. 2) when printing is performed on a sheet of printing paper. As illustrated in FIG. 9 as an example thereof, the driving signal COM includes discharging pulses PS (PS1, PS2). Herein, the discharging pulse PS is a pattern of a change in the level of electric potential (i.e., voltage) that is used for causing the piezoelectric elements PZT to perform predetermined operation so that the head HD discharges ink drops from nozzles Nz (refer to FIG. 5). Since the driving signal COM includes the discharging pulses PS, the driving signal generation circuit 30 described herein is an example of a discharging pulse generating section according to an aspect of the invention. The configuration of the driving signal generation circuit 30 will be explained later. A more detailed explanation of the discharging pulses PS will also be given later. The head unit 40 includes the head HD and a head control unit HC. The head HD, which ejects ink onto a sheet of paper in the form of liquid drops, is an example of a liquid discharging head according to an aspect of the invention. The head control unit HC controls the operation of the head HD on the basis of a head control signal that is supplied from the printer-side controller 60. The group of detection devices 50 is made up of a plurality of detectors that monitors the operation state of the printer 1. The result of detection performed by the plurality of detectors is outputted to the printer-side controller 60. The printer-side controller 60 controls the entire operation of the printer 1. The printer-side controller 60 is provided with an interface unit (I/F) 61, a CPU 62, and a memory 63.

### Main Components of Printer 1

### Head HD

FIG. 2 is a sectional view that schematically illustrates an example of the structure of the head HD viewed in the short-side direction of pressure generation chambers. FIG. 3 is a sectional view that schematically illustrates an example of the structure of the head HD viewed in the long-side direction of the pressure generation chambers. The head HD includes a fluid channel formation substrate 41. The fluid channel formation substrate 41 is made of, for example, a silicon single crystal substrate. A plurality of pressure generation chambers 42 is formed inside the fluid channel formation substrate 41. A plurality of partition walls demarcates the pressure generation chambers 42 as compartments. A reservoir 43 is formed in the neighborhood of one end of each pressure generation chamber 42 viewed in the long-side direction. The reservoir 43 is in communication with each pressure generation chamber 42 through an ink supply passage 44. Ink as an example of various kinds of liquid is supplied from the reservoir 43 to each pressure generation chamber 42 through the ink supply passage 44 (liquid supply passage). A vibrating plate (i.e., diaphragm) 45 is provided on one surface of the fluid channel formation substrate 41 that faces toward the piezoelectric elements PZT. A nozzle plate 46 is provided on the other surface of the fluid channel formation substrate 41. The nozzles Nz are formed through the nozzle plate 46. One nozzle Nz is provided for each pressure generation chamber 42.

A head case CA is attached to the vibrating plate 45. Ink supply tubes, which are not illustrated in the drawing, are provided on the head case CA. Ink is supplied from ink cartridges, which are not illustrated in the drawing, to the reservoir 43 through the supply tubes. A piezoelectric element unit PU is attached to the inside of the head case CA. In the attached state, the front end of each of the plurality of piezoelectric elements PZT, which are components of the piezoelectric element unit PU, is bonded to an island portion 45a. The island portion 45a is formed at each area on the vibrating plate 45 that corresponds to the area of the pressure generation chamber 42. In accordance with the deformation of the piezoelectric element PZT, the island portion 45a moves toward the pressure generation chamber 42 or away from the pressure generation chamber 42. As a result, the peripheral part of the vibrating plate 45 becomes deformed to change the capacity of the pressure generation chamber 42.

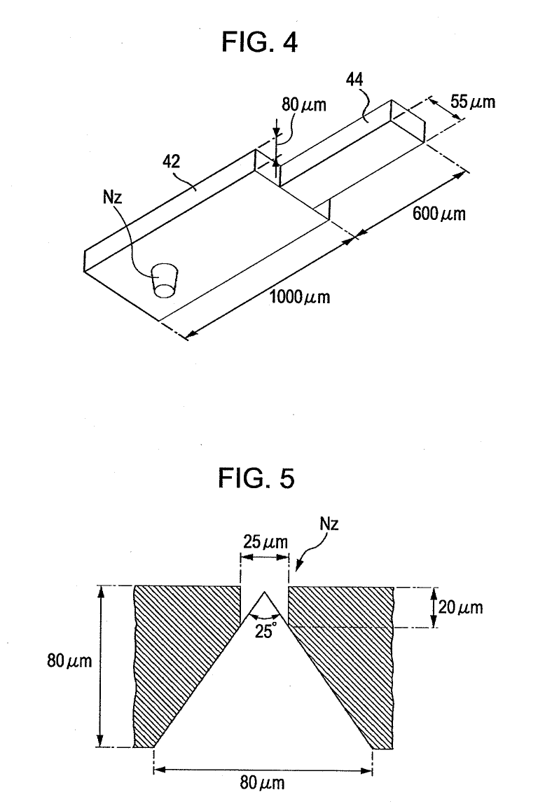

As illustrated in the model diagram of FIG. 4, the pressure generation chamber 42 is formed as a space that has the shape of a substantially rectangular parallelepiped. The ink supply passage 44 is also formed as a space that has the shape of a substantially rectangular parallelepiped. The length of the pressure generation chamber 42 according to the present embodiment of the invention is 1,000 μm. The height of the pressure generation chamber 42 is 80 μm. The length of the ink supply passage 44 according to the present embodiment of the invention is 600 μm. The width of the ink supply passage 44 is 55 μm, which is smaller than that of the pressure generation chamber 42. The height of the ink supply passage 44 is 80 μm, which is the same as that of the pressure generation chamber 42.

As illustrated in the model diagram of FIG. 5, the nozzle Nz is a part that is formed in the shape of a funnel. The nozzle Nz has a tapered portion and a straight portion. The diameter of the tapered portion of the nozzle Nz decreases gradually away from the pressure generation chamber 42. Accordingly, the diameter of the tapered portion measured at an end region most distant from the pressure generation chamber 42 is the smallest. The straight portion is formed in direct communication with the front end of the tapered portion, which is opposite the pressure-chamber-side (42) end. The straight portion defines a columnar space. In the structure of the nozzle Nz according to the present embodiment of the invention, the diameter of the tapered portion at the larger end is 80 μm, whereas the diameter of the tapered portion at the smaller end is 25 μm. The taper angle of the tapered portion is 25°. The diameter of the straight portion is 25 μm, which is the same as that of the tapered portion at the smaller end. The length of the straight portion is 20 μm. The entire length of the nozzle Nz, which is calculated by adding the length of the tapered portion to the length of the straight portion, is 80 μm.

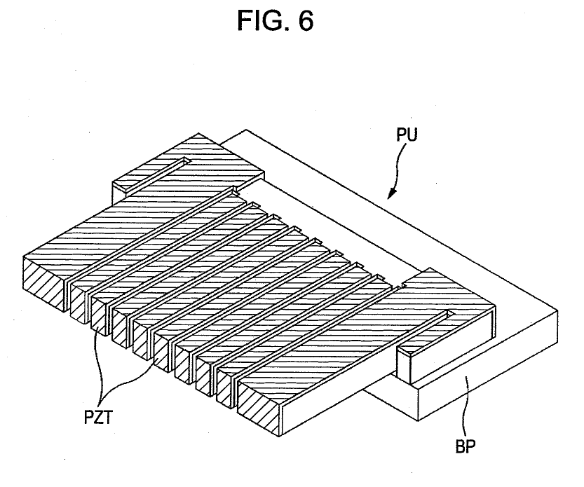

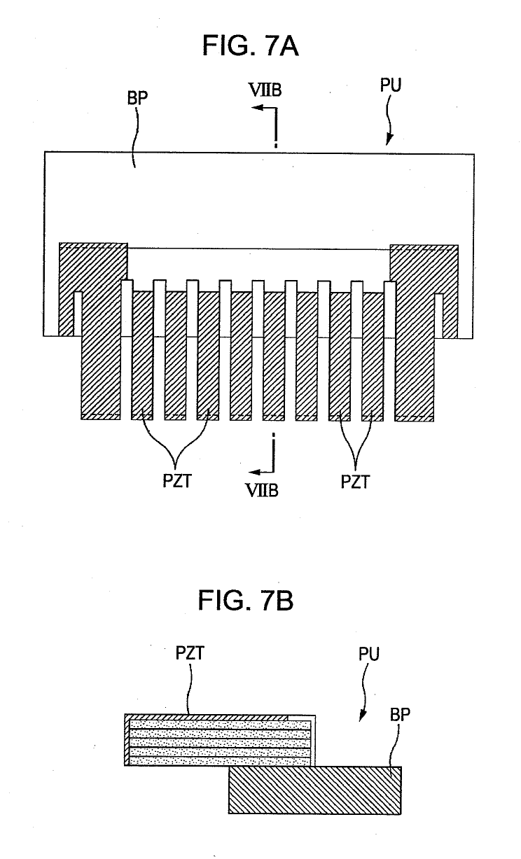

As illustrated in FIGS. 6 and 7, the piezoelectric element unit PU includes a group of piezoelectric elements PZT and a fixation board BP. The piezoelectric elements PZT are arrayed adjacent to one another in the width direction to make up the group of elements. Each piezoelectric element PZT is fixed to the fixation board BP in the shape of a cantilever. Each piezoelectric element PZT has a laminated structure that includes a piezoelectric substance layer, a driving electrode layer, and a common electrode layer. A plurality of slits is formed through a plate member that is made up of the piezoelectric substance layer, the driving electrode layer, and the common electrode layer with, for example, a wire saw, thereby forming the group of elements.

The piezoelectric element unit PU is provided with a positioner. The positioner is used for determining the position of the piezoelectric element unit PU with high precision when mounting the piezoelectric element unit PU to the head case CA.

As illustrated in FIG. 3, when the piezoelectric element unit PU having the structure explained above is mounted to the head case CA, one surface of the fixation board BP that is opposite the other element-side surface is attached to the head case CA. A film-type printed circuit substrate FP that supplies various kinds of signals for operating each piezoelectric element PZT is connected to the piezoelectric element unit PU.

When the driving signal COM is applied, the piezoelectric element PZT becomes deformed. The deformation movement of the piezoelectric element PZT is transmitted to the pressure generation chamber 42 via the vibrating plate 45. Due to the deformation of the piezoelectric element PZT, a pressure change occurs in ink retained in the pressure generation chamber 42. By this means, the head HD discharges an ink drop from the nozzle Nz. As explained above, the piezoelectric elements PZT of the piezoelectric element unit PU are mounted on the head case CA with the fixation board BP being provided therebetween. Because of such a structure, the vibrating plate 45 (the island portion 45a) is pulled away from the pressure generation chamber 42 when the piezoelectric element PZT contracts. As a result, the capacity of the pressure generation chamber 42 increases. On the contrary, the vibrating plate 45 is pushed toward the pressure generation chamber 42 when the piezoelectric element PZT expands. As a result, the capacity of the pressure generation chamber 42 decreases. A pressure change occurs in ink that is retained in the pressure generation chamber 42 due to the expansion/contraction of the pressure generation chamber 42. Specifically, the ink that is retained in the pressure generation chamber 42 is pressurized due to the contraction of the pressure generation chamber 42, whereas the ink that is retained in the pressure generation chamber 42 is depressurized due to the expansion of the pressure generation chamber 42.

The head HD ejects ink from the nozzles Nz utilizing such a pressure change. In such operation, the pressure generation chamber 42, the ink supply passage 44, and the nozzle Nz behave as a Helmholtz resonator. For this reason, the magnitude of pressure that is applied to ink retained in the pressure generation chamber 42 changes at a unique cycle that is called as Helmholtz frequency Tc. That is, pressure oscillation occurs in the ink. The Helmholtz frequency Tc is known also as the natural vibration frequency or the eigenfrequency of ink (liquid) retained in the pressure generation chamber 42.

Herein, the Helmholtz frequency Tc can be mathematically expressed by the following formula (4).

Tc=1/f

f=1/2π√[(Mn+Ms)/(Mn×Ms×(Cc+Ci))] (4)

In the above formula (4), Mn denotes the inertance of the nozzle Nz. The inertance of the ink supply passage 44 is denoted as Ms in the above formula (4). The compliance of the pressure generation chamber 42, which indicates a change in capacity per unit pressure, that is, the degree of softness, is denoted as Cc therein. The compliance of ink is denoted as Ci therein (where Ci=Volume V/[Density ρ×sonic velocity c²]).

In the above formula (4), the inertance M indicates the degree of easiness in the movement of ink through an ink flow channel (i.e., passage). The inertance M can be considered as the mass of ink per unit section area. The density of ink is denoted as p as shown in the above formula. Let a cross section taken along a plane orthogonal to the direction of the flow of ink through the flow channel be denoted as S. Let the length of the flow channel be denoted as L. Then, the inertance M can be approximately expressed by the following formula (5).

Inertance M=(Density ρ×Length L)/Section Area S (5)

As understood from the above formula (5), as the inertance increases, it becomes harder for ink to move in accordance with the pressure of the ink inside the pressure generation chamber 42. As the inertance decreases, it becomes easier for ink to move in accordance with the pressure of the ink inside the pressure generation chamber 42.

Due to the pressure oscillation of the Helmholtz frequency Tc, meniscus moves in the nozzle Nz periodically. It is possible to eject ink from the nozzle Nz efficiently by utilizing the pressure change of the Helmholtz frequency Tc. Since the expansion/contraction state of the piezoelectric element PZT is determined depending on the electric potential level of a driving electrode, the capacity of the pressure generation chamber 42 is also determined depending on the electric potential level of the driving electrode. Accordingly, it is possible to set the degree of pressurization/depressurization of ink that is retained in the pressure generation chamber 42 on the basis of the amount of a change in the electric potential level of the driving electrode per unit time.

### Driving Signal Generation Circuit 30

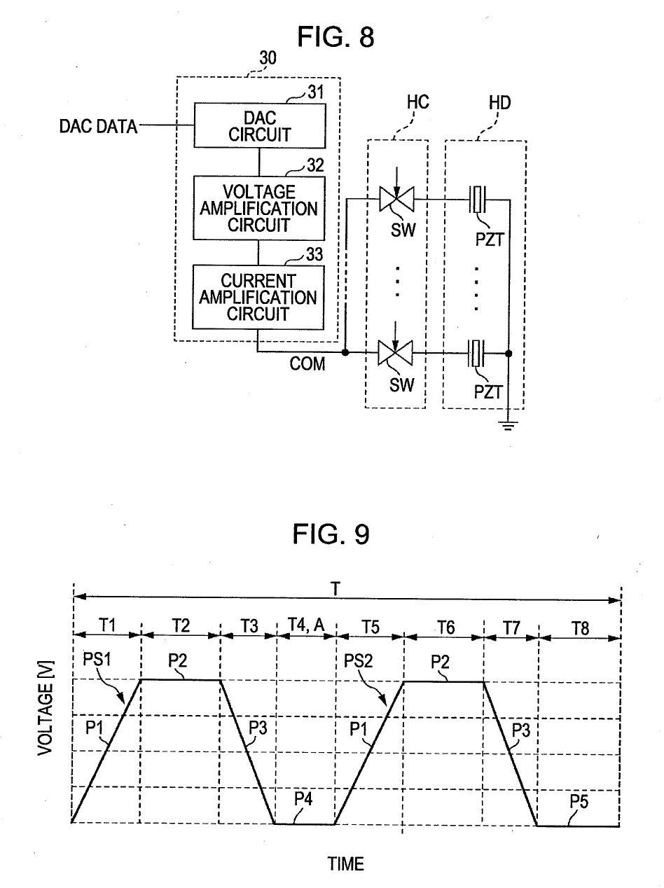

As explained earlier, the driving signal generation circuit 30 described herein functions as an example of a discharging pulse generating section according to an aspect of the invention. The driving signal generation circuit 30 generates a driving signal COM on the basis of DAC data, which represents the electric potential of the driving signal COM as digital values. As illustrated in FIG. 8, the driving signal generation circuit 30 includes a DAC circuit 31, a voltage amplification circuit 32, and a current amplification circuit 33. The DAC circuit 31 converts digital DAC data into an analog signal. The voltage amplification circuit 32 amplifies the level of the voltage of the analog signal, which has been generated by the DAC circuit 31 through the D/A conversion, to a value that is large enough to drive the piezoelectric elements PZT. In the configuration of the printer 1 according to the present embodiment of the invention, the level of an analog signal that is outputted from the voltage amplification circuit 32 after the amplification processing is 42V at the maximum whereas the level of an analog signal that is outputted from the DAC circuit 31 before the amplification processing is 3.3V at the maximum. The amplified analog signal that is outputted from the voltage amplification circuit 32 may be hereafter referred to as “waveform signal” for the purpose of simplifying its denotation. The current amplification circuit 33 amplifies the current level of the waveform signal that has been supplied from the voltage amplification circuit 32 and then outputs the current-amplified signal as a driving signal COM. The current amplification circuit 33 is made up of, for example, a pair of push-pull transistors.

### Head Control Unit HC

The head control unit HC selects a necessary part of the driving signal COM that was generated at the driving signal generation circuit 30 on the basis of a head control signal. Then, the head control unit HC applies the selected part of the driving signal COM to the piezoelectric elements PZT. In order to make such selection, as illustrated in FIG. 8, the head control unit HC is provided with a plurality of selection switches SW. The switch SW is provided for each of the plurality of piezoelectric elements PZT en route on a feeder line of the driving signal COM. The head control unit HC generates a switch control signal on the basis of the head control signal. Through the controlling of each switch SW with the use of the switch control signal, the head control unit HC selectively applies the necessary part of the driving signal COM (e.g., discharging pulse PS) to the piezoelectric element PZT.

### Driving Signal COM

Next, an explanation is given of a driving signal COM that is generated by the driving signal generation circuit 30. FIG. 9 is a diagram that schematically illustrates an example of the pulse pattern of the driving signal COM according to an exemplary embodiment of the invention. The vertical axis represents the voltage of the driving signal COM. The horizontal axis represents time. In the present embodiment of the invention, the driving signal generation circuit 30 generates the driving signal COM that has a voltage whose reference level (i.e., reference potential) is ground potential. In addition, the common electrode of the piezoelectric elements PZT is set at the ground potential. Therefore, the voltage of the driving signal COM indicates the electric potential of the driving electrode that is determined by the driving signal COM.

As illustrated in the drawing, the driving signal COM includes the discharging pulses PS (PS1, PS2). The driving signal COM is applied to the driving electrode. Upon the application of the driving signal COM to the driving electrode, a difference arises between the electric potential of the driving electrode and the electric potential of the common electrode in accordance with the waveform of the discharging pulses PS, which corresponds to the electric potential change pattern. Note that the electric potential of the common electrode is set at a fixed value. As a result, the piezoelectric element PZT expands/contracts in accordance with the waveform of the discharging pulses PS, thereby causing a change in the capacity of the pressure generation chamber 42.

The discharging pulses PS have a trapezoidal wave pattern. Upon the application of the discharging pulse PS having the shape of a trapezoidal pulse to the piezoelectric element PZT, the pressure generation chamber 42 expands first so that its capacity increases from the minimum capacity to the maximum capacity. The minimum capacity corresponds to the minimum electric potential. The maximum capacity corresponds to the maximum electric potential. Thereafter, the capacity of the pressure generation chamber 42 decreases to the minimum capacity. When the pressure generation chamber 42 contracts so that its capacity decreases from the maximum capacity to the minimum capacity, ink that is retained in the pressure generation chamber 42 is pressurized. Because of the increased pressure, ink is discharged from the nozzle Nz in the form of an ink drop.

In each of the discharging pulses PS1 and PS2 illustrated in FIG. 9, an upward slope part from the minimum voltage level to the maximum voltage level, that is, a pulse segment during the time period of which voltage changes from the minimum level to the maximum level is a depressurization segment P1. A downward slope part of each of the discharging pulses PS1 and PS2 from the maximum voltage level to the minimum voltage level, that is, a pulse segment during the time period of which voltage changes from the maximum level to the minimum level is a pressurization segment P3. A pulse segment during the time period of which voltage is kept at the maximum level after the application of the rising depressurization segment P1 is a flat plateau segment P2. Throughout the flat plateau segment P2, the piezoelectric element PZT is kept in a motionless state. Therefore, the discharging pulse PS explained above does not include any pulse segment for suppressing or damping excessive alternating movement of meniscus after the discharging of an ink drop. Such a pulse segment may be hereinafter referred to as a “vibration suppression segment”. Since the discharging pulse PS does not include the vibration suppression segment, it is possible to shorten the length of time that is required for the generation of discharging pulse PS. Therefore, it is possible to discharge ink drops at a higher frequency.

In each of the discharging pulses PS1 and PS2, the length of the time period of the depressurization segment P1 is 2.5 μs. The length of the time period of the flat plateau segment P2 is 3.0 μs. The length of the time period of the pressurization segment P3 is 2.0 μs. The length of the time period of each of the depressurization segment P1, the flat plateau segment P2, and the pressurization segment P3 in each discharging pulse PS as well as the minimum voltage level and the maximum voltage level can be arbitrarily adjusted depending on various factors such as, for example, the type of ink (liquid) that is to be discharged, the required drop movement speed, and the length of the tail of an ink drop (liquid drop). The drop movement speed is the speed of the movement of a discharged drop in the air. The driving signal generation circuit 30 generates a minimum level waveform segment P4 during the time period of which voltage is kept at the minimum level. The minimum level waveform segment P4 follows the preceding discharging pulse PS1. The minimum level waveform segment P4 corresponds to a time period T4, which continues till the start of the generation of the following discharging pulse PS2. The minimum level waveform segment P4 is a connection segment between the preceding discharging pulse PS1 and the following discharging pulse PS2. Thus, the generation period of the minimum level waveform segment P4 is a time period from the end of the preceding discharging pulse PS1 to the start of the following discharging pulse PS2. In addition, the driving signal generation circuit 30 generates another minimum level waveform segment P5 during the time period of which voltage is kept at the minimum level. The minimum level waveform segment P5 follows the following discharging pulse PS2. The generation period of the minimum level waveform segment P5 continues till the next cycle period T starts. The driving signal generation circuit 30 generates the driving signal COM, which includes the discharging pulses PS1 and PS2, repeatedly. The preceding discharging pulse PS1 and the following discharging pulse PS2 are included in each period T.

When high viscosity ink that has viscosity of ten millipascal seconds or greater is ejected by means of a driving signal, it is difficult to ensure stable discharging of ink drops if no consideration is given to a time interval between a preceding discharging pulse and a following discharging pulse, which is a problem of related art. In view of the foregoing problem, the printer 1 generates the preceding discharging pulse PS1 and the following discharging pulse PS2 with a pulse interval that satisfies the following mathematical formulae (1) and (2). The pulse interval, which is shown as a time period A in the drawing, starts at the end of the preceding discharging pulse PS1 and ends at the start of the following discharging pulse PS2. The preceding discharging pulse PS1 described herein is an example of an anterior discharging pulse according to an aspect of the invention. The following discharging pulse PS2 described herein is an example of a posterior discharging pulse according to an aspect of the invention.

$$\begin{matrix}O ≦ A ≦ Xv max - \frac{1}{20} Tc & ( 1 ) \\ Xv max + ( \frac{10 n + 1}{20} ) Tc ≦ A ≦ Xv max + ( \frac{10 n + 9}{20} ) Tc & ( 2 )\end{matrix}$$

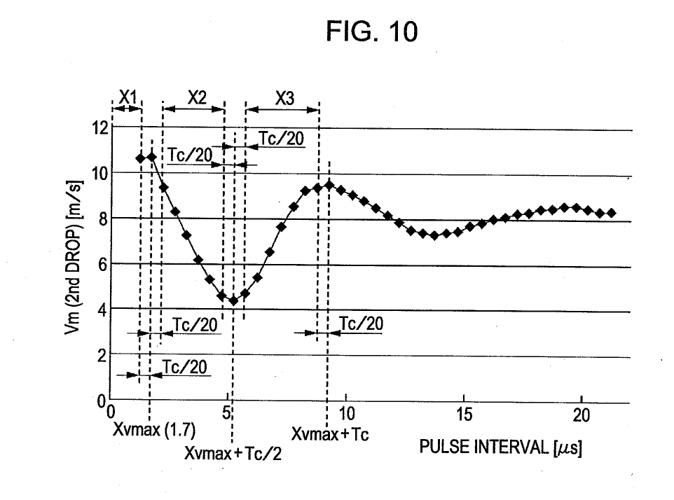

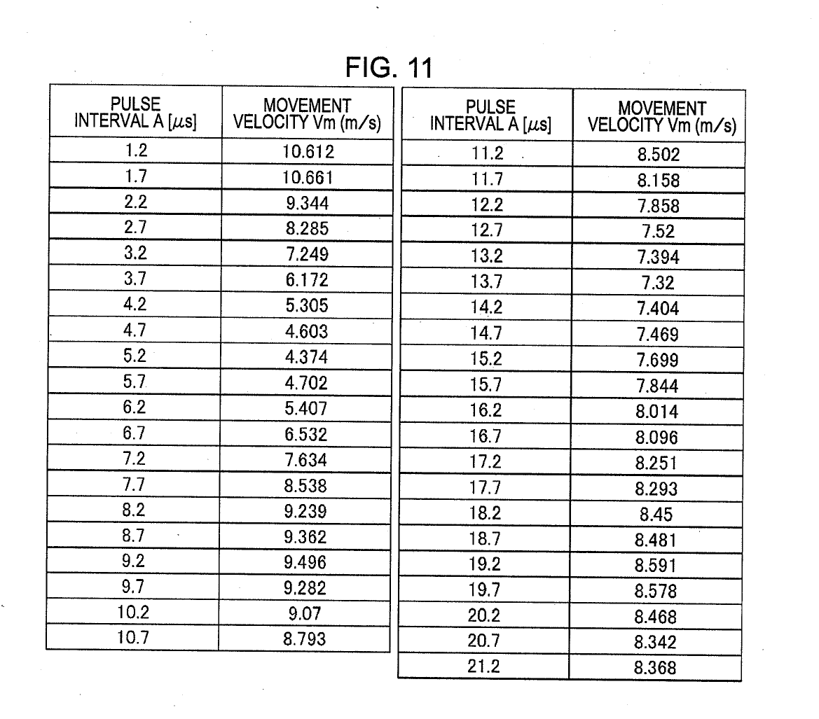

FIG. 10 is a graph that shows an example of a relationship between the pulse interval (time period T4) from the end of the preceding discharging pulse PS1 to the start of the following discharging pulse PS2 and the in-the-air moving speed of an ink drop that is discharged when driven by the following discharging pulse PS2. The vertical axis of FIG. 10 represents the speed of the movement of an ink drop in the air when the ink drop is discharged by means of the following discharging pulse PS2. The horizontal axis of FIG. 10 represents the pulse interval. FIG. 11 shows measurement data on the basis of which points are plotted in the graph of FIG. 10.

From these drawings, it is understood that the in-the-air moving speed of an ink drop that is discharged when driven by the following discharging pulse PS2 changes periodically. Specifically, for example, the highest movement velocity of the ink drop in the air, which is 10.661 m/s, is obtained when the pulse interval is 1.7 μs. Therefore, Xvmax for the head HD used in the illustrated measurement example equals to 1.7. The Helmholtz frequency Tc of this head HD is 9 μs. The movement velocity of the ink drop in the air decreases as the pulse interval increases from 1.7 μs. The in-the-air moving speed reaches the lowest value, 4.374 m/s, when the pulse interval is 5.2 μs. The movement velocity of the ink drop in the air increases as the pulse interval increases from 5.2 μs. The in-the-air moving speed is 9.496 m/s when the pulse interval is 9.2 μs.

It can be inferred that a change in the speed of the movement of a discharged ink drop in the air is attributable to pressure oscillation that occurs in ink retained in the pressure generation chamber 42 in response to the application of the preceding discharging pulse PS1. That is, it can be inferred that the change is attributable to residual vibration after the discharging of an ink drop. Therefore, the speed of the movement of a discharged ink drop in the air changes in accordance with the Helmholtz frequency Tc.

The mathematical formula (1) shown above corresponds to a range denoted as X1 in FIG. 10. The mathematical formula (2) shown above corresponds to ranges denoted as X2 and X3 in FIG. 10. Herein, 9/20 Tc (n=0) indicates a point in time (i.e., timing) that is earlier than 1/2 Tc by 1/20 Tc, whereas 11/20 Tc (n=1) indicates a point in time that is later than 1/2 Tc by 1/20 Tc. In like manner, 19/20 Tc (n=1) indicates a point in time that is earlier than Tc by 1/20 Tc.

As understood from FIG. 10, with attention focused on the fact that the speed of the movement of a discharged ink drop in the air changes in accordance with the Helmholtz frequency Tc, the pulse interval of the printer 1 is set with a shift amount of ±1/20 Tc or greater from the peak velocity timing and the bottom velocity timing. By this means, it is possible to discharge an ink drop with stable discharging performance.

### Evaluation Result

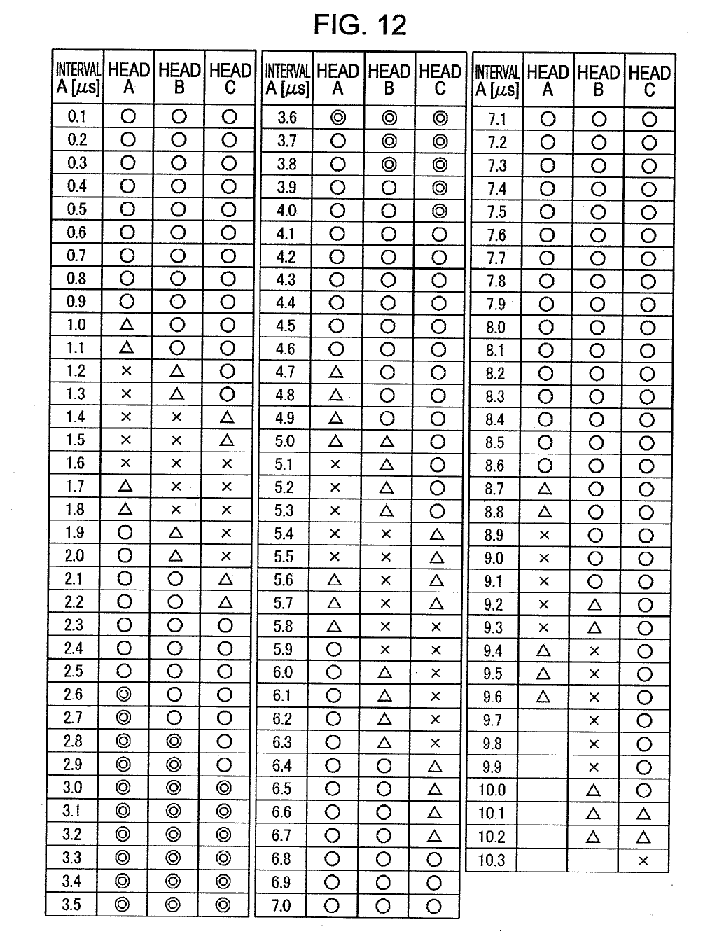

FIG. 12 is a diagram that shows a result of the evaluation of stability performance when an ink drop is discharged. In the illustrated evaluation, three types of heads HD were used. The first head A is a head that offers its highest movement velocity for the second ink drop (i.e., the subsequent ink drop that follows the first ink drop) in the air when the max-velocity pulse interval Xvmax is 1.4 μs. The Helmholtz frequency Tc of the head A is 7.8 μs. The second head B is a head that offers its highest movement velocity for the second ink drop in the air when the max-velocity pulse interval Xvmax is 1.5 μs. The Helmholtz frequency Tc of the head B is 8.3 μs. The third head C is a head that offers its highest movement velocity for the second ink drop in the air when the max-velocity pulse interval Xvmax is 1.7 μs. The Helmholtz frequency Tc of the head C is 9 μs.

In the table of the evaluation result illustrated in FIG. 12, each double-circle sign indicates that the ink drop of interest is discharged in an ideal state. Each single-circle sign indicates that the ink drop of interest is discharged straightforward. Each triangle sign indicates that the ink drop of interest is discharged with its tail part being bent, which is visible to the eye. Each x-indication sign indicates that the ink drop of interest is not discharged at all. In this evaluation, it was judged that the ink drop of interest was discharged with stable performance for each observation result that is shown by either the double-circle sign or the single-circle sign. It was judged that the ink drop of interest was not discharged with stable performance for each observation result that is shown by either the triangle sign or the “X” sign.

The evaluation result of the head A was good as indicated by the single-circle sign for a range of the pulse interval from 0.1 μs inclusive to 0.9 μs inclusive. As described above, the Helmholtz frequency Tc of the head A is 7.8 μs. The max-velocity pulse interval Xvmax of the head A is 1.4 μs. Accordingly, “Xvmax−1/20 Tc” approximately equals to 1.0 μs. In FIG. 12, the evaluation result of the head A for the pulse interval 1.0 μs is marked as triangle. However, this evaluation result is probably attributable to an error. Therefore, it can be said that the head A satisfies the above formula (1).

The evaluation result of the head A was good as indicated by the single-circle sign or excellent as indicated by the double-circle sign for a range of the pulse interval from 1.9 μs inclusive to 4.6 μs inclusive. Specifically, the evaluation result of the head A is marked as single circle for a range of the pulse interval from 1.9 μs inclusive to 2.5 μs inclusive and a range of the pulse interval from 3.7 μs inclusive to 4.6 μs inclusive. The evaluation result of the head A is marked as double circle for a range of the pulse interval from 2.6 μs inclusive to 3.6 μs inclusive. For the head A, “Xvmax+1/20 Tc” and “Xvmax+9/20 Tc” approximately equal to 1.8 μs and 4.9 μs, respectively. In FIG. 12, the evaluation result of the head A for a range of the pulse interval from 4.7 μs inclusive to 4.9 μs inclusive is marked as triangle. However, this evaluation result is probably attributable to an error. Therefore, it can be said that the head A satisfies the above formula (2) in a case where n equals to zero.

The evaluation result of the head A was good as indicated by the single-circle sign for a range of the pulse interval from 5.9 μs inclusive to 8.6 μs inclusive. For the head A, “Xvmax+11/20 Tc” and “Xvmax+19/20 Tc” approximately equal to 5.7 μs and 8.8 μs, respectively. In FIG. 12, the evaluation result of the head A for a range of the pulse interval from 5.7 μs inclusive to 5.8 μs inclusive and a range of the pulse interval from 8.7 μs inclusive to 8.8 μs inclusive is marked as triangle. However, this evaluation result is probably attributable to an error. Therefore, it can be said that the head A satisfies the above formula (2) in a case where n equals to one.

The evaluation result of the head B was good as indicated by the single-circle sign for a range of the pulse interval from 0.1 μs inclusive to 1.1 μs inclusive. As described above, the Helmholtz frequency Tc of the head B is 8.3 μs. The max-velocity pulse interval Xvmax of the head B is 1.5 μs. Accordingly, “Xvmax−1/20 Tc” approximately equals to 1.1 μs. Therefore, it can be said that the head B satisfies the above formula (1).

The evaluation result of the head B was good as indicated by the single-circle sign or excellent as indicated by the double-circle sign for a range of the pulse interval from 2.1 μs inclusive to 4.9 μs inclusive. Specifically, the evaluation result of the head B is marked as single circle for a range of the pulse interval from 2.1 μs inclusive to 2.7 μs inclusive and a range of the pulse interval from 3.9 μs inclusive to 4.9 μs inclusive. The evaluation result of the head B is marked as double circle for a range of the pulse interval from 2.8 μs inclusive to 3.8 μs inclusive. For the head B, “Xvmax+1/20 Tc” and “Xvmax+9/20 Tc” approximately equal to 1.9 μs and 5.1 μs, respectively. In FIG. 12, the evaluation result of the head B for a range of the pulse interval from 1.9 μs inclusive to 2.0 μs inclusive and a range of the pulse interval from 5.0 μs inclusive to 5.1 μs inclusive is marked as triangle. However, this evaluation result is probably attributable to an error. Therefore, it can be said that the head B satisfies the above formula (2) in a case where n equals to zero.

The evaluation result of the head B was good as indicated by the single-circle sign for a range of the pulse interval from 6.4 μs inclusive to 9.1 μs inclusive. For the head B, “Xvmax+11/20 Tc” and “Xvmax+19/20 Tc” approximately equal to 6.1 μs and 9.4 μs, respectively. In FIG. 12, the evaluation result of the head B for a range of the pulse interval from 6.1 μs inclusive to 6.3 μs inclusive and a range of the pulse interval from 9.2 μs inclusive to 9.3 μs inclusive is marked as triangle. In addition, the evaluation result of the head B for the pulse interval 9.4 μs marked as “X”. However, this evaluation result is probably attributable to an error. Therefore, it can be said that the head B satisfies the above formula (2) in a case where n equals to one.

The evaluation result of the head C was good as indicated by the single-circle sign for a range of the pulse interval from 0.1 μs inclusive to 1.3 μs inclusive. As described above, the Helmholtz frequency Tc of the head C is 9 μs. The max-velocity pulse interval Xvmax of the head C is 1.7 μs. Accordingly, “Xvmax−1/20 Tc” approximately equals to 1.3 μs. Therefore, it can be said that the head C satisfies the above formula (1).

The evaluation result of the head C was good as indicated by the single-circle sign or excellent as indicated by the double-circle sign for a range of the pulse interval from 2.3 μs inclusive to 5.3 μs inclusive. Specifically, the evaluation result of the head C is marked as single circle for a range of the pulse interval from 2.3 μs inclusive to 2.9 μs inclusive and a range of the pulse interval from 4.1 μs inclusive to 5.3 μs inclusive. The evaluation result of the head C is marked as double circle for a range of the pulse interval from 3.0 μs inclusive to 4.0 μs inclusive. For the head C, “Xvmax+1/20 Tc” and “Xvmax+9/20 Tc” approximately equal to 2.2 μs and 5.8 μs, respectively. In FIG. 12, the evaluation result of the head C for the pulse interval 2.2 μs and a range of the pulse interval from 5.4 μs inclusive to 5.7 μs inclusive is marked as triangle. In addition, the evaluation result of the head C for the pulse interval 5.8 μs is marked as “X”. However, this evaluation result is probably attributable to an error. Therefore, it can be said that the head C satisfies the above formula (2) in a case where n equals to zero.

The evaluation result of the head C was good as indicated by the single-circle sign for a range of the pulse interval from 6.8 μs inclusive to 10.0 μs inclusive. For the head C, “Xvmax+11/20 Tc” and “Xvmax+19/20 Tc” approximately equal to 6.7 μs and 10.3 μs, respectively. In FIG. 12, the evaluation result of the head C for the pulse interval 6.7 μs and a range of the pulse interval from 10.1 μs inclusive to 10.2 μs inclusive is marked as triangle. In addition, the evaluation result of the head C for the pulse interval 10.3 μs is marked as “X”. However, this evaluation result is probably attributable to an error. Therefore, it can be said that the head C satisfies the above formula (2) in a case where n equals to one.

### Consideration

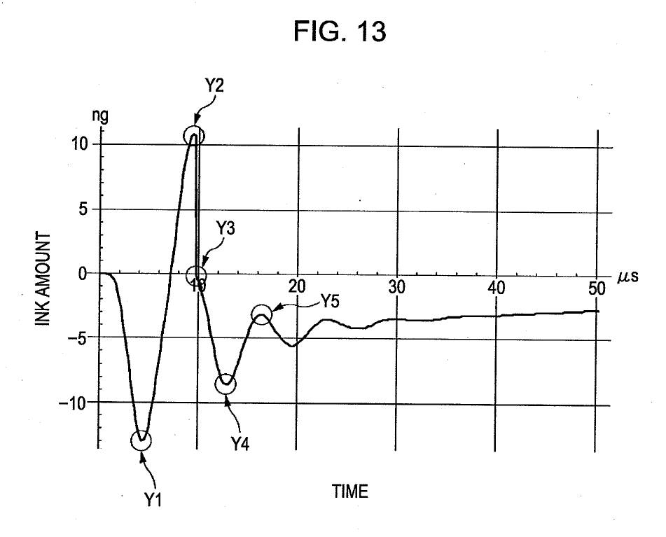

The reason for successful discharging of an ink drop with stable performance is studied. FIG. 13 is a diagram that schematically illustrates an example of meniscus movement when the preceding discharging pulse PS1 is applied to the piezoelectric element PZT. The vertical axis of FIG. 13 represents the movement of meniscus, which is expressed as the amount of ink. In the drawing, 0 ng indicates meniscus in stationary state. Positive ink amount indicates that discharging pressure that acts in the discharging direction is being applied to meniscus. The larger the positive ink amount is, the greater the discharging pressure is. Negative ink amount indicates that a sucking force toward the pressure generation chamber 42 is being applied to meniscus. The larger the absolute value of the negative ink amount is, the larger the sucking force is. The horizontal axis of FIG. 13 represents elapsed time since the application of the preceding discharging pulse PS1 is started.

It is understood from FIG. 13 that meniscus moves as explained below. As a first step, upon the application of the depressurization segment P1 of a pulse to the piezoelectric element PZT, meniscus is sucked from stationary state toward the pressure generation chamber 42. The movement of the meniscus toward the pressure generation chamber 42 continues during the time period in which the flat plateau segment P2 of the pulse is being applied to the piezoelectric element PZT, too. Thereafter, the movement direction of the meniscus is reversed at time denoted as Y1. In synchronization with this reversal timing, the application of the pressurization segment P3 of the pulse to the piezoelectric element PZT is started. Due to the application of the pressurization segment P3, the meniscus moves in the discharging direction rapidly. After the application of the pressurization segment P3, a front-end part of the meniscus (i.e., ink) comes off at time denoted as Y2. The part is discharged as an ink drop. On the other hand, the remaining part of the meniscus moves back toward the pressure generation chamber 42 rapidly as a reaction of the discharging of the ink drop.

The time period that is expressed as Xvmax±1/20 Tc is shown as time Y3 in FIG. 13. This time period is, in other words, a certain period immediately after the discharging of the ink drop. The reason why the time period Y3 is excluded is that, if the generation of the following discharging pulse PS2 were started in the time period Y3 for application to the piezoelectric element PZT, the meniscus would move excessively. The time expressed as Xvmax+9/20 Tc, Xvmax+11/20 Tc is shown as time Y4 in FIG. 13. This time is, in other words, time before and after the reversal of the moving direction of the meniscus, which has moved back toward the pressure generation chamber 42, to the discharging direction. The reason why the time period Y4 is excluded is that, if the generation of the following discharging pulse PS2 were started in the time period Y4 for application to the piezoelectric element PZT, the meniscus would not be sucked in sufficiently. The same holds true for Xvmax+19/20 Tc, Xvmax+21/20 Tc, that is, time Y5.

The reason for successful discharging of an ink drop with stable performance when the generation of the following discharging pulse PS2 is started in the time period corresponding to the pulse interval from 0 μs to Xvmax−1/20 Tc for application to the piezoelectric element PZT can be considered as follows. If the front-end part of a meniscus were discharged as an ink drop as it came off naturally from the remaining part without pre-thinning the thick base-end part, the rear part of the ink drop might exert an undesirable force that acts in a direction other than the moving direction on the front part of the ink drop in the process of the natural separation of the front-end part. For this reason, there is a risk of a shift in the moving direction. In contrast, in a case where the generation of the following discharging pulse PS2 is started for application to the piezoelectric element PZT before the front-end part of a meniscus comes off, a suction force acts from the pressure generation chamber 42 on the base-end part of the meniscus to move the base-end part toward the pressure generation chamber 42. This is the reason why an ink drop can be discharged with stable performance.

### Other Exemplary Embodiments of the Invention

A printing system that includes the printer 1 as an example of a liquid discharging apparatus according to an aspect of the invention is mainly described in the foregoing exemplary embodiment of the invention. In addition, the foregoing description includes the disclosure of a liquid discharging method and a liquid discharging system. The foregoing disclosure further includes a liquid discharging head and a method for controlling a liquid discharging head. Although the present invention is explained above with the disclosure of an exemplary embodiment, the specific embodiment is provided solely for the purpose of facilitating the understanding of the invention. The above explanatory embodiment should not be interpreted to limit the scope of the invention. The invention may be modified, altered, changed, adapted, and/or improved within a range not departing from the gist and/or spirit of the invention apprehended by a person skilled in the art from explicit and implicit description made herein, where such a modification, an alteration, a change, an adaptation, and/or an improvement is also encompassed within the scope of the appended claims. It is the intention of the inventor/applicant that the scope of the invention covers any equivalents thereof. As specific examples, the following variations are encompassed within the scope of the invention.

### Driving Signal COM

In the foregoing exemplary embodiment of the invention, the size of a dot is not taken into consideration at all. However, it is preferable that an anterior discharging pulse (e.g., the preceding discharging pulse PS1) and a posterior discharging pulse (e.g., the following discharging pulse PS2) should be generated with a pulse interval that satisfies the following mathematical formula (3) when a large dot is to be formed by means of the preceding discharging pulse PS1 and the following discharging pulse PS2. That is, when the piezoelectric element PZT is operated through application of an anterior discharging pulse and a posterior discharging pulse in order to discharge an ink drop of a certain desired discharge amount, it is preferable to generate the anterior discharging pulse and the posterior discharging pulse with a pulse interval that satisfies the following mathematical formula (3).

$$Xv max + \frac{1}{20} Tc ≦ A ≦ Xv max + \frac{9}{20} Tc \qquad ( 3 )$$

### Elements Activating Discharging Operation

The printer 1 according to the foregoing exemplary embodiment of the invention and the modification example explained above is provided with the piezoelectric elements PZT, which function as elements that activate the ejection of ink. However, an element that activates the ejection of ink is not limited to the piezoelectric element PZT explained above. Any alternative element that operates in accordance with the level of an applied voltage to cause a pressure change in liquid retained in the pressure generation chamber 42 may be used as a substitute for the piezoelectric element PZT. A magnetostrictive element is an example of various alternative elements. If the piezoelectric element PZT is used as an element that activates the ejection of ink as described in the foregoing exemplary embodiment of the invention, it is possible to control the capacity of the pressure generation chamber 42 with high precision on the basis of the voltage level of a discharging pulse PS. That is, it is possible to finely control the pressure of liquid such as ink retained in the pressure generation chamber 42.

### Viscosity of Ink

The upper limit of the viscosity of ink is set at a level that does not preclude discharging of the ink from the nozzle Nz in the form of an ink drop. For example, it is set at 30 millipascal seconds.

### Other Application Examples

In the foregoing description of an exemplary embodiment of the invention, the printer 1 is taken as an example of a liquid discharging apparatus according to an aspect of the invention. However, the scope of the invention is not limited to such a specific example. For example, a technique that is the same as or similar to the liquid ejection technique disclosed in the foregoing exemplary embodiment of the invention may be applied to various kinds of liquid discharging apparatuses that include, without any limitation thereto, a color filter manufacturing apparatus, a dyeing apparatus, a micro-fabrication/micro-machining apparatus, a semiconductor manufacturing apparatus, a surface treatment apparatus, a three-dimensional (3D) modeling apparatus, a liquid gasification apparatus, an organic electroluminescence (EL) manufacturing apparatus (in particular, a polymer EL manufacturing apparatus), a display manufacturing apparatus, a film deposition apparatus, and a DNA chip manufacturing apparatus. In addition to a variety of apparatuses enumerated above, the scope of the present invention encompasses methods and manufacturing methods corresponding to these apparatuses.

The entire disclosure of Japanese Patent Application No. 2008-311325, filed Dec. 5, 2008 is expressly incorporated by reference herein.

What is claimed is:

1. A liquid discharging apparatus comprising:
a pressure chamber that is in communication with a nozzle;
an element that operates to cause a pressure change in liquid retained in the pressure chamber; and
a discharging pulse generating section that generates a discharging pulse for operating the element to discharge the liquid from the nozzle,
wherein the discharging pulse generating section generates an anterior discharging pulse and a posterior discharging pulse in such a manner that a time period A from the end of the anterior discharging pulse to the start of the posterior discharging pulse satisfies the following formula (1).
$$O ≦ A ≦ Xv max - \frac{1}{20} Tc \qquad ( 1 )$$

2. A liquid discharging apparatus comprising:
a pressure chamber that is in communication with a nozzle;
an element that operates to cause a pressure change in liquid retained in the pressure chamber; and
a discharging pulse generating section that generates a discharging pulse for operating the element to discharge the liquid from the nozzle,
wherein the discharging pulse generating section generates an anterior discharging pulse and a posterior discharging pulse in such a manner that a time period A from the end of the anterior discharging pulse to the start of the posterior discharging pulse satisfies the following formula (2).
$$Xv max + ( \frac{10 n + 1}{20} ) Tc ≦ A ≦ Xv max + ( \frac{10 n + 9}{20} ) Tc \qquad ( 2 )$$

3. A liquid discharging apparatus comprising:
a pressure chamber that is in communication with a nozzle;
an element that operates to cause a pressure change in liquid retained in the pressure chamber; and
a discharging pulse generating section that generates a discharging pulse for operating the element to discharge the liquid from the nozzle,
wherein the discharging pulse generating section generates an anterior discharging pulse and a posterior discharging pulse in such a manner that a time period A from the end of the anterior discharging pulse to the start of the posterior discharging pulse satisfies the following formula (3) when the element is operated through application of the anterior discharging pulse and the posterior discharging pulse in order to discharge a liquid drop of a certain desired discharge amount.
$$Xv max + \frac{1}{20} Tc ≦ A ≦ Xv max + \frac{9}{20} Tc \qquad ( 3 )$$

4. The liquid discharging apparatus according to claim 1, wherein the anterior discharging pulse is a trapezoidal pulse; and the posterior discharging pulse is a trapezoidal pulse that has the same voltage level change pattern as that of the anterior discharging pulse.

5. The liquid discharging apparatus according to claim 1, wherein the element is a piezoelectric element that becomes deformed in accordance with the voltage level of an applied discharging pulse to cause a change in the capacity of the pressure chamber, thereby causing a pressure change in the liquid retained in the pressure chamber.
